(19) United States
(12) Patent Application Publication
(10) Pub. No.: US 2013/0314939 A1
(43) Pub. Date: Nov. 28, 2013

(54) LIGHT EMITTING DEVICE

(71) Applicants: Zhi-Ting Ye, Miaoli County (TW); Chin-Liang Chen, Taichung City (TW); Ming-Chuan Lin, Taichung City (TW); Tang-Hao Weng, Taichung City (TW)

(72) Inventors: Zhi-Ting Ye, Miaoli County (TW); Chin-Liang Chen, Taichung City (TW); Ming-Chuan Lin, Taichung City (TW); Tang-Hao Weng, Taichung City (TW)

(73) Assignee: WINTEK CORPORATION, Taichung City (TW)

(21) Appl. No.: 13/900,536

(22) Filed: May 23, 2013

(30) Foreign Application Priority Data
May 24, 2012 (TW) 101209919

(51) Int. Cl. F21K 99/00

(52) U.S. Cl. CPC F21K 9/52
USPC 362/551

(57) ABSTRACT

A light emitting device including a light guide pillar, a reflective layer, and a point light source is provided. The light guide pillar has a light incident terminal surface and includes a first portion and a second portion located between the first portion and the light incident terminal surface. The reflective layer is disposed on the first portion and exposes a portion of the first portion. The reflective layer is not disposed on the second portion. The point light source emits light toward the light incident terminal surface.

### CROSS-REFERENCE TO RELATED APPLICATION

This application claims the priority benefit of Taiwan application serial no. 101209919, filed on May 24, 2012. The entirety of the above-mentioned patent application is hereby incorporated by reference herein and made a part of this specification.

### BACKGROUND OF THE INVENTION

1. Field of Invention

The invention relates to a light emitting device and more particularly, to a light emitting device utilizing a point light source.

2. Description of Related Art

Owing that the luminance efficiency of a light emitting diode (LED) has been increasingly enhanced in recent years, the LED is gradually replacing the traditional light source in many fields. Since the luminance of the LED is not caused by thermal emission or electric discharge emission but by cold luminance, the life span of the LED may be more than 100,000 hours. In addition, the LED also has advantages of high responding speed (about 10⁻⁹ s), small size, low power consumption, little pollution, high reliability, being adapted for mass production and so on so that the LED is suitable for being used in various fields.

However, the LED is a point light source having highly directional characteristic, which causes the light emitting effect of concentrated beam distribution and uneven brightness so that the application of the LED could be limited. Regarding to an interior illumination device, the uniformity of the brightness is always emphasized. Therefore, the issue on how to out-couple the concentrated light beam in an even distribution manner is important when the LED is applied in the illumination device.

### SUMMARY OF THE INVENTION

The invention provides a light emitting device, capable of transforming the point light source into an evenly distributed linear light source.

The invention is directed to a light emitting device including a light guide pillar, a reflective layer and a point light source. The light guide pillar has a light incident terminal surface and includes a first portion and a second portion located between the light incident terminal surface and the first portion. The reflective layer is disposed on the first portion and partially exposes the first portion, wherein the reflective layer is not disposed on the second portion. The point light source emits light toward the light incident terminal surface.

According to an embodiment of the invention, the reflective layer has a width of W1 in a direction perpendicular to an extension direction of the light guide pillar. The second portion has a length of W2 in the extension direction of the light guide pillar. A ratio of W1/W2 is from 0.8 to 1.2. In addition, the ratio of W1/W2 can be 0.9 to 1.1. Alternately, W1 is 9 mm to 11 mm and W2 is 8 mm to 10 mm. Furthermore, W1 is 16 mm and W2 is 15 mm.

According to an embodiment of the invention, the second portion has a plurality of microstructures. The disposition area of the microstructures is substantially overlapped with an extension area on the second portion defined by extending the reflective layer toward the light incident terminal surface in the extension direction of the light guide pillar. Each of the microstructures has a first inclined surface and a second inclined surface. A width of the second portion is gradually increased from the light incident terminal surface to the first portion by the first inclined surface. The first inclined surface is located between the second inclined surface and the light incident terminal surface and connected to the second inclined surface to form a protruding angle, wherein the protruding angle is from 82 degrees to 88 degrees. In addition, the included angle of the first inclined surface of each microstructure including the extension direction of the light guide pillar is from 2 degrees to 8 degrees. In the extension direction of the light guide pillar, a length of the first inclined surface can be greater than a length of the second inclined surface.

According to an embodiment of the invention, a main light emitting direction of the point light source is substantially parallel to the extension direction of the light guide pillar.

According to an embodiment of the invention, a light emitting angle of the point light source ranges 120 degrees.

According to an embodiment of the invention, the point light source keeps a distance of 1 mm from the light incident terminal surface.

According to an embodiment of the invention, the point light source is an LED.

In view of the above, no reflective layer is disposed on the portion of the light guide pillar adjacent to the light incident terminal surface in the light emitting device according to the embodiment of the invention. The light emitted from the point light source can be subjected to the effects of the light guide pillar and the reflective layer to provide an even linear light source. Specifically, when a user watches the light emitting device at an oblique direction, the brightness of the portion adjacent to the light incident terminal surface is similar to the brightness of the other portion, which prevents the glare phenomenon at the portion adjacent to the light incident terminal surface. Therefore, the light emitting device according to the embodiment of the invention has desirable light emitting effect and is capable of being applied in various fields.

In order to make the aforementioned and other features and advantages of the present invention more comprehensible, several embodiments accompanied with figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic view of a light emitting device according to an embodiment of the invention.

FIG. 2 is a schematic view illustrating the light guide pillar and the reflective layer of the light emitting device depicted in FIG. 1 when watching the light emitting device from a side of the reflective layer.

FIG. 3 is a schematic view of a light emitting device according to another embodiment of the invention.

FIG. 4 is a cross-sectional view of the light guide pillar and the reflective layer in the light emitting device depicted in FIG. 3 and the cross-section is taken along the extension direction of the light guide pillar.

FIG. 5 is a schematic view illustrating the light guide pillar and the reflective layer of the light emitting device depicted in FIG. 3 when watching the light emitting device from a side of the reflective layer.

### DESCRIPTION OF EMBODIMENTS

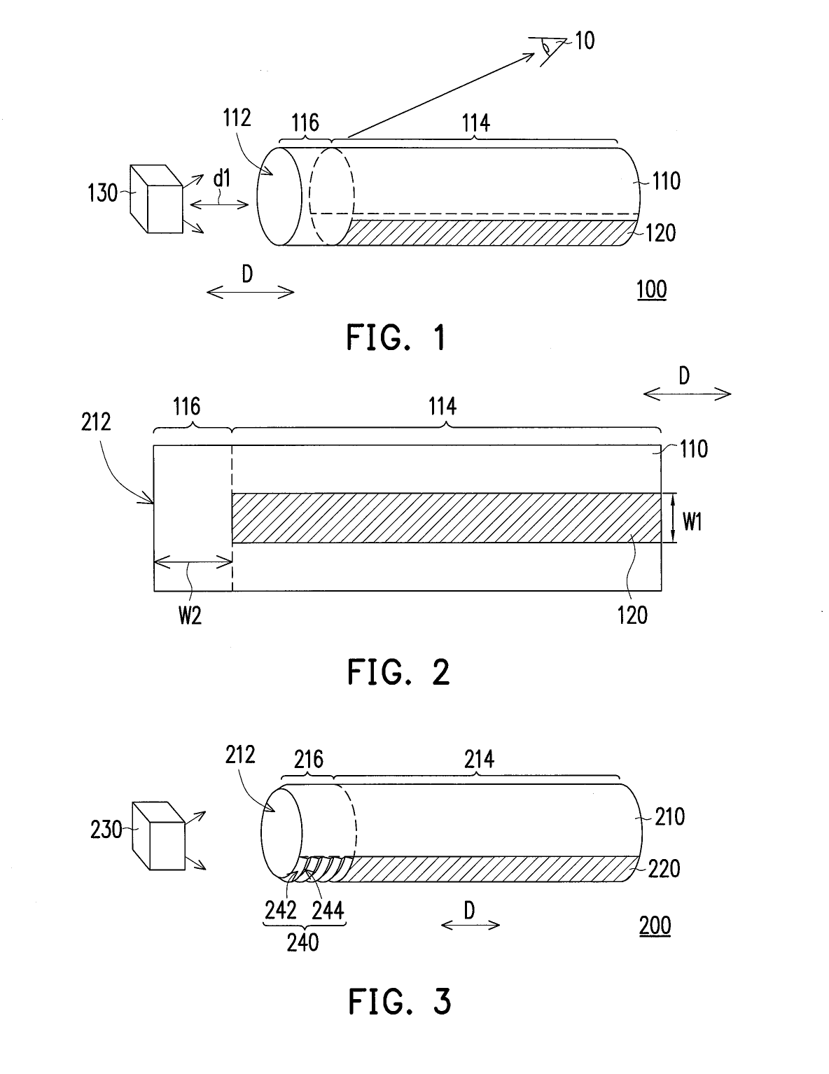

FIG. 1 is a schematic view of a light emitting device according to an embodiment of the invention. Referring to FIG. 1, the light emitting device 100 includes a light guide pillar 110, a reflective layer 120 and a point light source 130. The light guide pillar 110 has a light incident terminal surface 112 and can be divided into a first portion 114 and a second portion 116 located between the light incident terminal surface 112 and the first portion 114. The reflective layer 120 is disposed on the first portion 114 and partially exposes the first portion 114. In addition, the point light source 130 emits light toward the light incident terminal surface 112. Accordingly, the point light source 130 substantially faces to the light incident terminal surface 112 of the light guide pillar 110. It is noted that the reflective layer 120 according to the present embodiment is not disposed on the second portion 116 and not disposed between the first portion 114 and the light incident terminal surface 112.

The light guide pillar 110, for example, can be made of polymethyl methacrylate (PMMA), polycarbonate (PC), or other transparent light guide material. The reflective layer 120 can be fabricated using white ink material or other diffusing reflective material. In general, the light guide pillar 110 and the reflective layer 120 can be fabricated by a dual-material extrusion-forming process. Namely, in the extrusion-forming process, the reflective material and the light guide material can be both filled into the mold fixture and the two materials are extruded from the mold fixture to form a pillar structure. In the present embodiment, the reflective material at a portion of the pillar structure adjacent to at least one terminal surface is further removed to form the light guide pillar 110 and the reflective layer 120 as depicted in FIG. 1. Accordingly, the light guide pillar 110 can have the first portion 114 with the reflective layer 120 thereon and the second portion 116 without the reflective layer 120 thereon.

Furthermore, the light guide pillar 110 in the present embodiment has a pillar-like structure so that the shape of the light guide pillar 110 defines an extension direction D. When the light incident terminal surface 112 is a flat surface, the extension direction D can be substantially served as a direction perpendicular to the light incident terminal surface 112 or served as the normal direction of the light incident terminal surface 112. The first portion 114 and the second portion 116 are two portions of the light guide pillar 110 arranged adjacent to each other in the extension direction D. Nevertheless, the light guide pillar 110 is fabricated by the extrusion-forming process and formed integrally so that the first portion 114 and the second portion 116 are divided based on the configuration location of the reflective layer 120 and no gap or interface is required between the first portion 114 and the second portion 116.

The point light source 130 can be an LED or other point light source capable of emitting light, wherein the point light source 130 can have a light emitting angle in the range of 120 degrees. The point light source 130 can be disposed by keeping a distance of 1 mm from the light incident terminal surface 112, i.e. the distance d1 can be about 1 mm. Generally, the light emitted from the point light source 130 is guided by the light guide pillar 110 after entering the light guide pillar 110 so as to be transmitted inside the light guide pillar 110. The reflective layer 120 is used for reflecting the light transmitted inside the light guide pillar 110 toward the side the user 10 is located. Therefore, the location of the user 10 and the location of the reflective layer 120 are substantially at two opposite sides of the light guide pillar 110.

Generally, after the light emitted from the point light source 130 enters the light guide pillar 116, the second portion 116 closer to the point light source 130 than the first portion 114 receives more light. Once the reflective layer 120 is disposed on both the first portion 114 and the second portion 116, the user 10 could feel higher brightness at the second portion 116 adjacent to the light incident terminal surface 112 and thus have uncomfortable feeling, which is called the glare phenomenon. The reflective layer 116 is not disposed on the second portion 116 based on the design of the present embodiment, which is conducive to eliminate the light intensity emitted from the second portion 116. Therefore, the glare phenomenon at the second portion 116 which discomforts the user 10 is reduced according to the design of the present embodiment. That is, the light emitting device 100 can have desirable light emitting uniformity.

Particularly, FIG. 2 is a schematic view illustrating the light guide pillar and the reflective layer of the light emitting device depicted in FIG. 1 when watching the light emitting device from a side of the reflective layer. Referring to FIG. 2, the reflective layer 120 has a width of W1 in a direction perpendicular to the extension direction D of the light guide pillar 110 and the second portion 116 has a length of W2 in the extension direction D of the light guide pillar 110. Herein, a ratio of W1/W2 is from 0.8 to 1.2. In addition, the ratio of W1/W2 can selectively be 0.9 to 1.1. Alternately, W1 is about 9 mm to 11 mm and W2 is about 8 mm to 10 mm. Furthermore, in an alternate embodiment, W1 is 16 mm and W2 is 15 mm. In the present embodiment, the width W1 of the reflective layer 120 is measured in a cross-section when the extension direction D is served as the normal direction of the cross section. Though the reflective layer 120 is formed to have a curve shape, the value of the width W1 can be substantially a straight linear width of the reflective layer 120 in the view of FIG. 2.

For evaluating the light emitting effect of the light emitting device designed according to the present embodiment, several simulation samples are performed, wherein the point light source and the light guide pillar are set to be the same in these simulation samples and the reflective layers disposed on the light guide pillars of different simulation samples are set to be different. It is found that in a comparative simulation sample which has the reflective layer disposed on the light incident portion of the light guide pillar adjacent to the light incident terminal surface as well as the other portion of the light guide pillar, the brightness at the light incident portion is about 695 Im (lumen) and the brightness at the central portion of the light guide pillar is about 510 lm. In other words, the light emitting uniformity of the light emitting device is about 73.3% when the reflective layer is disposed on both the light incident portion and the other portion of the light guide pillar. Alternately, in a simulation sample designed according to the present embodiment, the brightness at the second portion 116 is about 635 Im and the brightness at the central portion of the light guide pillar 110 is about 612 Lm. In other words, the light emitting uniformity of the light emitting device is about 96.3% when the reflective layer 120 is not disposed on the second portion 116 served as the light incident portion. The two simulations represent that the light emitting uniformity of the light emitting device 110 according to the present embodiment is significantly improved due to the reflective layer 120 is not disposed on the second portion 116 and the effect that the second portion 116 is brighter can be suppressed.

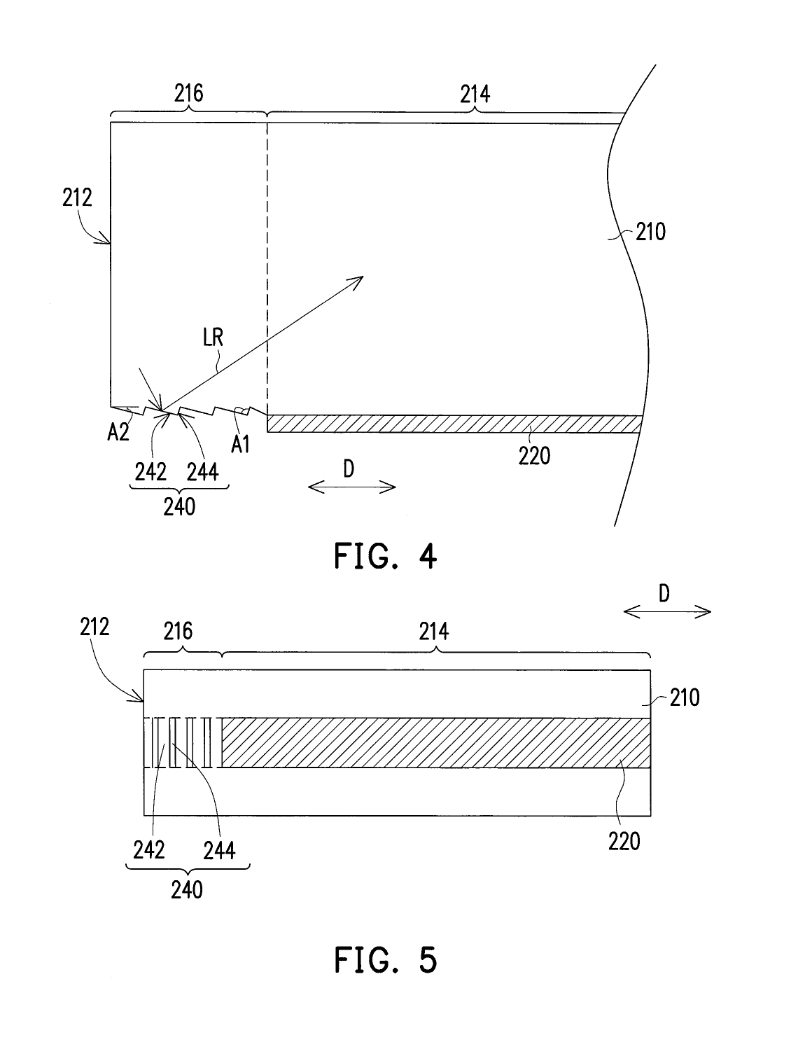

Note that the cylinder shape structure of the light guide pillar 110 shown in FIG. 1 and FIG. 2 is merely exemplary and should not be construed as limitations of the present invention. In other embodiments, the light guide pillar can also have polygonal pillar shapes and the light incident terminal surface 112 is not limited to have a circle shape. Furthermore, the second portion 116 of the light guide pillar 110 can selectively have a smooth surface or a rough (non-smooth) surface. FIG. 3 is a schematic view of a light emitting device according to another embodiment of the invention. FIG. 4 is a cross-sectional view of the light guide pillar and the reflective layer in the light emitting device depicted in FIG. 3 and the cross-section is taken along the extension direction of the light guide pillar. Referring to FIG. 3, the light emitting device 200, similar to the light emitting device 100 in the prior embodiment, includes a light guide pillar 210, a reflective layer 220 and a point light source 230. The light guide pillar 210 has a light incident terminal surface 212 and includes a first portion 214 and a second portion 216 located between the light incident terminal surface 212 and the first portion 214. The reflective layer 220 is disposed on the first portion 214 and partially exposes the first portion 214. In addition, the point light source 230 emits light toward the light incident terminal surface 212. Accordingly, the point light source 230 substantially faces to the light incident terminal surface 212 of the light guide pillar 210. It is noted that the reflective layer 220 according to the present embodiment is also not disposed on the second portion 216.

Specifically, the difference between the present embodiment and the embodiment depicted in FIG. 1 mainly lies in that the second portion 226 of the present embodiment has a plurality of microstructures 240. As shown in FIG. 3 and FIG. 4, each microstructure 240 has a first inclined surface 242 and a second inclined surface 244. The configuration of the first inclined surface 242 renders the width of the second portion 216 gradually increased from the light incident terminal surface 212 to the first portion 214, which defines the inclination direction of the first inclined surface 242. In addition, the first inclined surface 242 can be located between the second inclined surface 244 and the light incident terminal surface 212 and connected to the second inclined surface 244 to form a protruding angle A1 which is from 82 degree to 88 degree. Furthermore, the first inclined surface 242 of each microstructure 240 includes the extension direction D in an included angle A2 of 2 degrees to 8 degrees.

According to FIG. 5, a disposition area of the microstructures 240 can be substantially overlapped with an extension area on the second portion 216 when the extension area is defined by extending the reflective layer 220 toward the light incident terminal surface 212 along the extension direction D of the light guide pillar 210. In the present embodiment, a reflective material and a light guide material can be extruded from a mold fixture through a dual-material extrusion-forming process to form an embryo structure of the light guide pillar 210 and the reflective layer 220. Afterward, a portion of the reflective material in the embryo structure is further removed to expose a microstructure disposition area and the microstructures 240 is then formed on the exposed microstructure disposition area to form the light guide pillar 210 and the reflective layer 220 as depicted in FIGS. 3, 4 and 5.

Herein, the length of the first inclined surface 242 can be greater than the length of the second inclined surface 244 in the extension direction D of the light guide pillar 210. Compared with the design of the light guide pillar without configured with the microstructures 240, the light emitted from the point light source 230 as shown in FIG. 3 can enter the light guide pillar 210 from the light incident terminal surface 212 and irradiate on the first inclined surface 242 at a greater incident angle. Therefore, the light LR as shown in FIG. 4 reflected by the first inclined surface 242 is liable to be guided and transmitted farther from the light incident terminal and toward another terminal of the light guide pillar 210 inside the light guide pillar 210 ( ). Accordingly, the amount of the light emitted from the second portion 216 of the light guide pillar 210 can be reduced, which eliminates the glare phenomenon of the user. That is to say, the design of the present embodiment and the prior embodiment depicted in FIG. 1 and FIG. 2 can efficiently improve the light emitting effect of the light emitting devices 100 and 200 so that the light emitting devices 100 and 200 can both have desirable light emitting uniformity.

In light of the foregoing, the reflective layer is disposed on the light guide pillar and exposes a portion of the light guide pillar adjacent to the light incident terminal surface according to the embodiments of the invention. By subjecting the effect of the light guide pillar and the reflective layer, the light emitted from the point light source can be evenly distributed in the extension direction of the light guide pillar and the brighter phenomenon at the portion adjacent to the light incident terminal surface of the light guide pillar is eliminated. Therefore, the light emitting device according to an embodiment of the invention has uniformed light emitting effect.

Although the invention has been described with reference to the embodiments thereof, it will be apparent to one of the ordinary skills in the art that modifications to the described embodiments may be made without departing from the spirit of the invention. Accordingly, the scope of the invention will be defined by the attached claims not by the above detailed description.

What is claimed is:

1. A light emitting device, comprising:
a light guide pillar having a light incident terminal surface and comprising a first portion and a second portion located between the light incident terminal surface and the first portion;
a reflective layer disposed on the first portion and partially exposing the first portion, wherein the reflective layer is not disposed on the second portion; and
a point light source emitting light toward the light incident terminal surface.

2. The light emitting device as claimed in claim 1, wherein the reflective layer has a width of W1 in a direction perpendicular to an extension direction of the light guide pillar, the second portion has a length of W2 in the extension direction of the light guide pillar, and a ratio of W1/W2 is from 0.8 to 1.2.

3. The light emitting device as claimed in claim 2, wherein the ratio of W1/W2 is from 0.9 to 1.1.

4. The light emitting device as claimed in claim 2, wherein W1 is from 9 mm to 11 mm and W2 is from 8 mm to 10 mm.

5. The light emitting device as claimed in claim 2, wherein W1 is 16 mm and W2 is 15 mm.

6. The light emitting device as claimed in claim 1, wherein the second portion has a plurality of microstructures, and an disposition area of the microstructures is substantially overlapped with an extension area on the second portion defined by extending the reflective layer toward the light incident terminal surface along an extension direction of the light guide pillar.

7. The light emitting device as claimed in claim 6, wherein each of the microstructures has a first inclined surface and a second inclined surface, a width of the second portion is gradually increased from the light incident terminal surface toward the first portion at the first inclined surface, the first inclined surface is located between the second inclined surface and the light incident terminal surface and connected to the second inclined surface to form a protruding angle, and the protruding angle is from 82 degrees to 88 degrees.

8. The light emitting device as claimed in claim 7, wherein an included angle defined by the first inclined surface of each microstructure and the extension direction of the light guide pillar is from 2 degrees to 8 degrees.

9. The light emitting device as claimed in claim 7, wherein a length of the first inclined surface is greater than a length of the second inclined surface in the extension direction of the light guide pillar.

10. The light emitting device as claimed in claim 1, wherein a light emitting angle of the point light source ranges 120 degrees.

11. The light emitting device as claimed in claim 1, wherein the light emitting surface keeps a distance of 1 mm from the light incident terminal surface.
